(19) United States
(12) Patent Application Publication
(10) Pub. No.: US 2017/0228929 A1
(43) Pub. Date: Aug. 10, 2017

(54) System and Method by which combining computer hardware device sensor readings and a camera, provides the best, unencumbered Augmented Reality experience that enables real world objects to be transferred into any digital space, with context, and with contextual relationships.

(71) Applicant: Patrick Dengler, Redmond, WA (US)

(72) Inventor: Patrick Dengler, Redmond, WA (US)

(21) Appl. No.: 14/841,706

(22) Filed: Sep. 1, 2015

(51) Int. Cl. G06T 19/00; H04N 5/232; G06K 9/00; G06T 13/60

(52) U.S. Cl. CPC G06T 19/006; G06T 13/60; H04N 5/23293; G06T 19/003; G06K 9/00671; G06T 2210/22

(57) ABSTRACT

Fragmented Reality provides an unencumbered full immersion augmented/virtual reality with object transfer from real world to digital.

Utilizing a combination of the digital compass, a gyroscope, the accelerometer, infrared and GPS, this software detects exactly where the user and their “Camera” is in real space and translates it to digital space, providing for a merging of real world and digital world. Further, it adds the ability to move real objects into the digital world using object and image detection and other heuristics.

### DETAILED DESCRIPTION OF THE INVENTION

All other virtual technology technologies either require a device to be affixed to the head and cover the eyes, or for the user to be in a fixed room or fixed space.

Additionally none of them transfer real objects into virtual reality.

Fragmented Reality software, requires only a smart phone, and can be used anywhere. It allows the user to play in a room, or outside, or while traveling on a plane. They are no physical constraints or extra equipment needed. And a deeper immersion experience is obtained by transferring object from real to digital space allowing them to interact once transferred.

### The Components

1. A software component can be built and used across several different types of hardware devices, presenting an end user with an entirely new perspective by projecting 3d applications onto the screen and optionally mixed with a real-time camera view creating an illusion of actually being inside the application or movie; Fragmented Reality expands upon the experiences to date known as either Virtual Reality or Augmented Reality, combining them, and image and object detection with a supporting metamodel-positioning database which enables real world objects to be transferred into an application, with context, and with contextual relationships, to create a Virtual, Augmented Real-World Reality.
2. A “camera view, whereas the user is placed directly within the space and context of a 3d software application, to examine or experience the 3d space from a truly 1st person perspective and Utilizing available sensors on the device to translate either GPS coordinates and/or acceleration vectors by use of gyroscopes, finely tuned and self-tuning algorithms that provide precise placement of the user within the world's context down to the inch and

### Specialized, Polyalgorithmic Compliments

3. Optional or additional 4th person camera view where remote locations can be presented to the user on screen via publicly available video feeds of fixed place cameras, which are stored in the “metal base” (the Fragmented Reality metamodel-material-positioning database)
4. Also, Fragmented Reality uses a combination of object detection, specially tuned for, specially tuned for all objects, and image search to accurately detect objects in the viewport and matches that information to Fragmented Reality MetelBase to transfer 3d models into the application space;
5. These 3d models have mass, in their simplest case, and have context (such as a car that can be driven) and a more complex case.
6. Objects that are transferred from the real-world into the digital users space can react to each other based upon position and related effects as described in the MetelBase (such as a bottle of coke placed near Mentos will create a water fountain effect.

### How the Components Work Together

1. Acquire computing device with motion and gps sensors, and an optional camera.
2. Install an app or game that uses Fragmented Reality.
3. Elements of the game are projected onto the device screen, and the position and rotation of the device determine the position and angle of the camera.
4. Information available about the users' location including geospatial data acquired from any available registered source, will be placed into the game as well (for example, a house, or a car driving by).
5. The user can use the scan button when the camera is aimed at an object and attempt to bring it into the game. If the image is recognized, and a 3d model exists, the model will be placed into the game with context (i.e. a purely static object, or a proper car that drives, or a water fountain that shoots water).
6. If satellite data is available, select closest satellite. Store other satellite for reference if the current satellite data becomes less accurate.
7. If Accelerometer has noise, use a combination of the GPS data and a low noise and optimal filter to get the position.
8. If object 1 is near object 2, check relationship for reactive distance and execute action on object or objects. If object is detected, and image search successful, find model in the metelbase; if the model has context, apply the context (such as a car or a person).
9. If the model allows for texture replacement, lift the texture from the camera image and average the colors.

### How to Reproduce the Invention

One would have to understand the complexities of many technologies, including hardware, sensors and cross platform languages; and have the solid knowledge of 3D math and 3D graphics in order to be able to begin to think to put these together. Then, if someone were to combine them, they would spend several months tuning the algorithms. If after several months they realize there is no way to tune them standalone, they would put a learning algorithm over the top of the algorithms. All of the positioning algorithms and sensor access are necessary. The camera view (augmented view) and the object detection and image detection could stand alone.

### How to Use the Invention

1. Install the Fragmented Reality component software on a development computer.
2. Using the instructions, integrate the software into the view and the camera using the public API's.
3. Enable sensor access in the application
4. Optionally upload additional models and context into the metelbase.

### SUMMARY

Fragmented Reality blurs the users experience such that the digital word and the real world merge into one experience.

### BRIEF DESCRIPTION OF THE DRAWINGS

FIG. 1—Blur/Fragmented Reality: Initialization

FIG. 3 depicts the flow surrounding the steps necessary to initialize the component including detecting initial position, reading in heightmap information and starting up calibration.

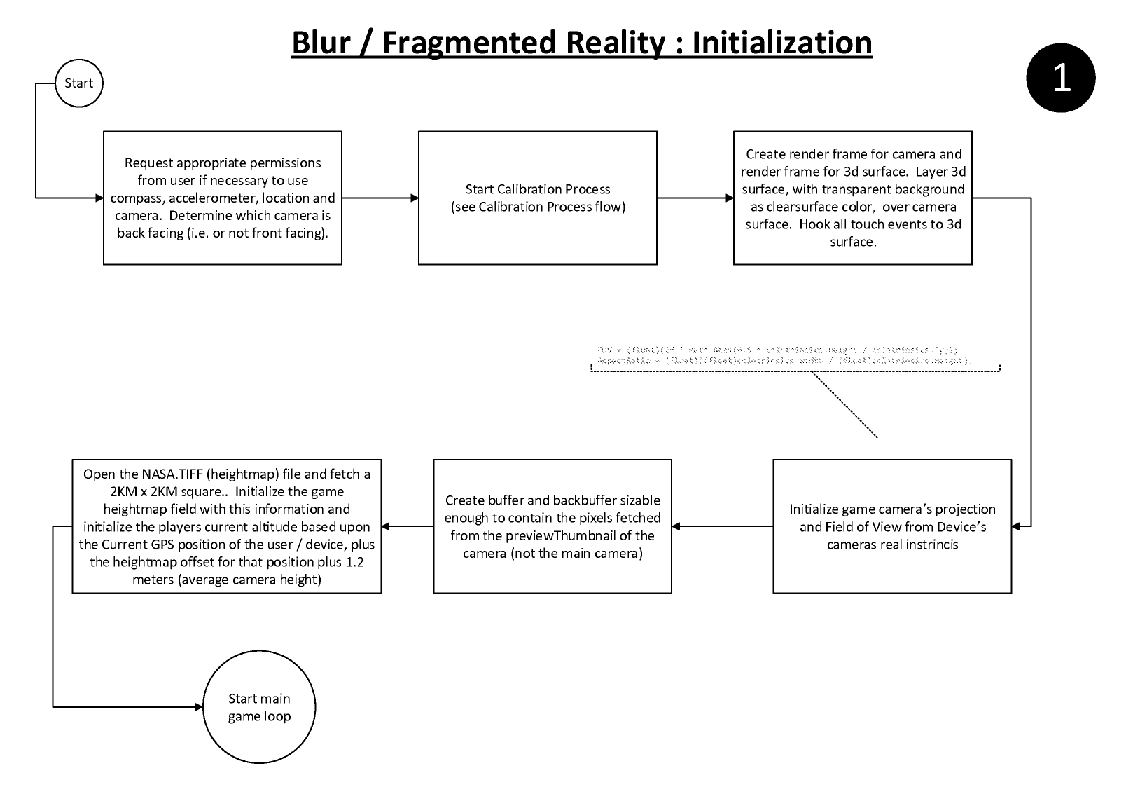

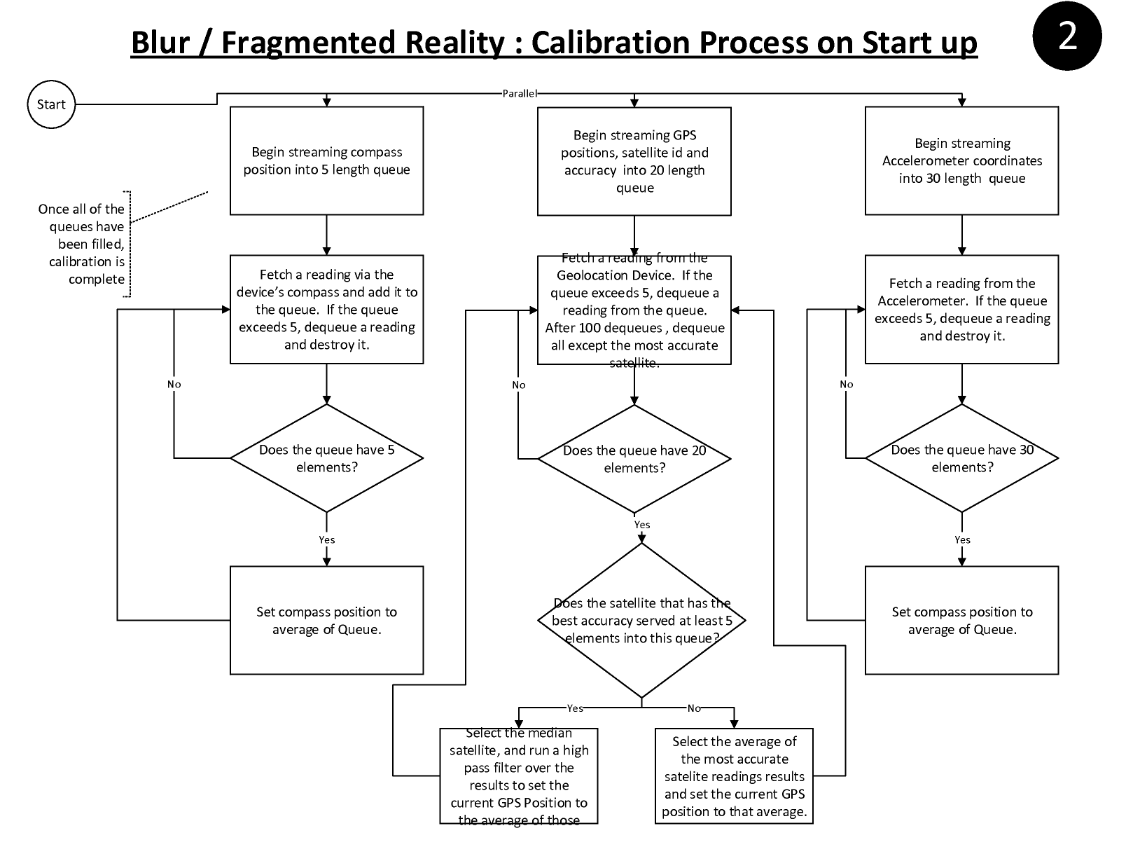

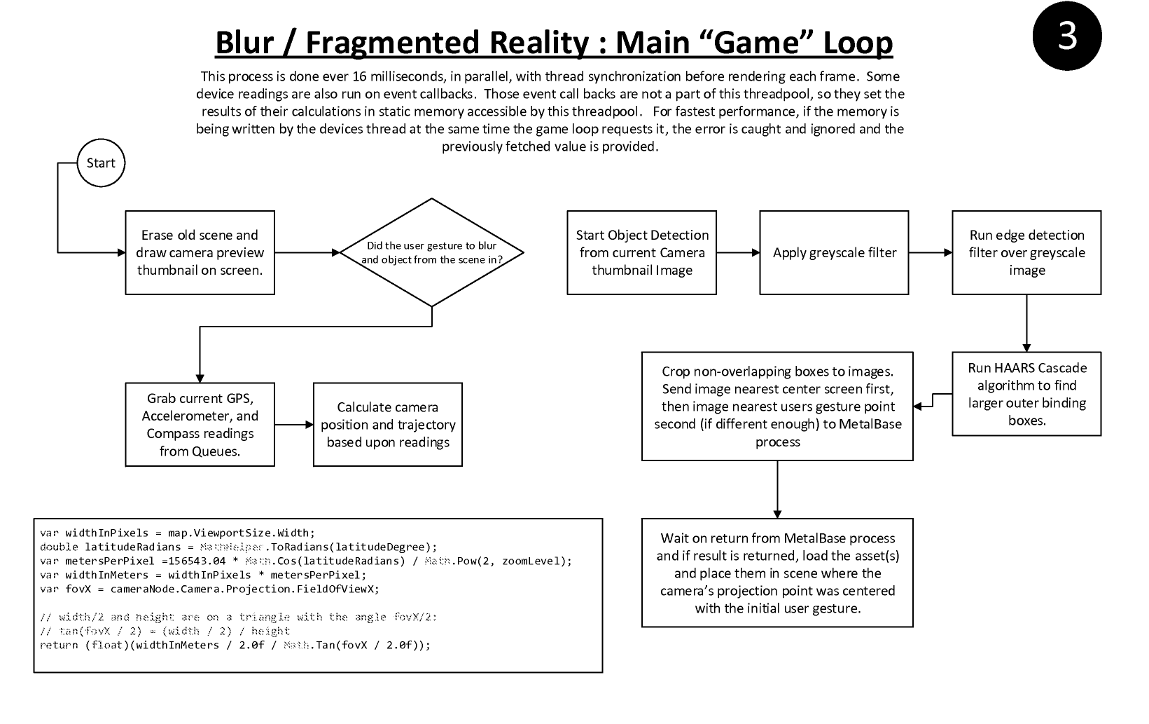

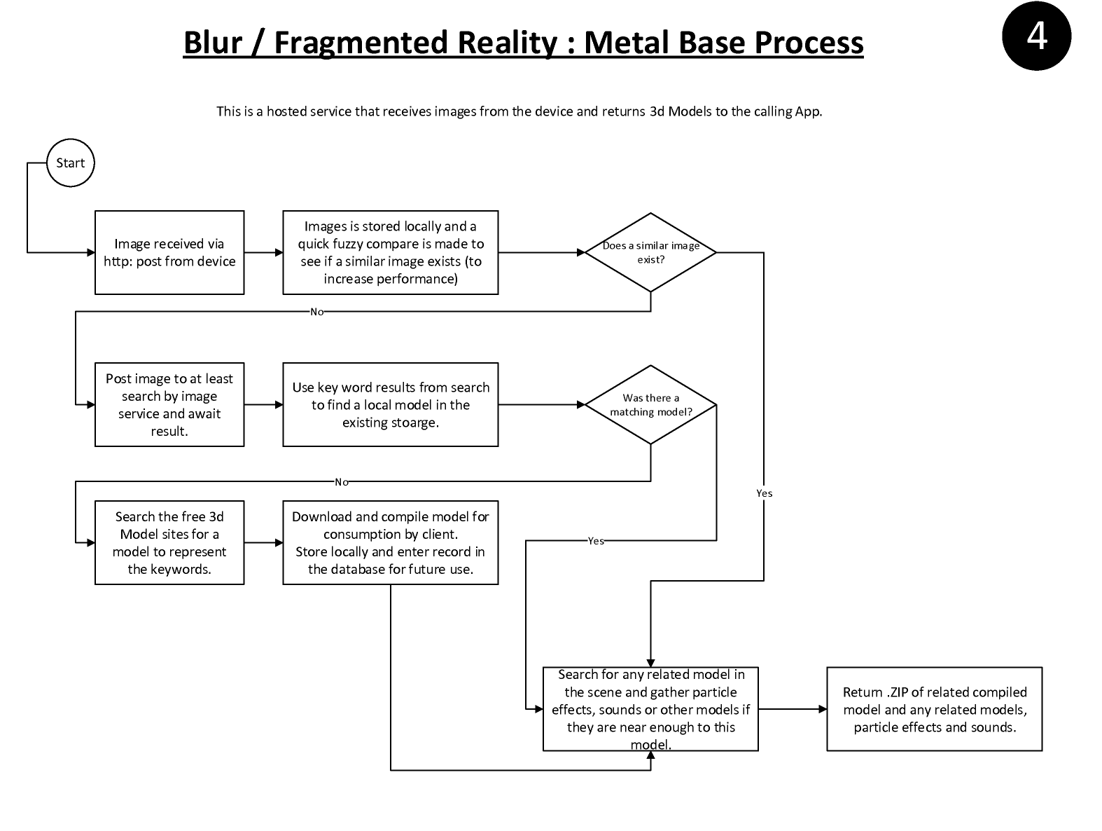

FIG. 2—Blur/Fragmented Reality: Calibration Process on Start up

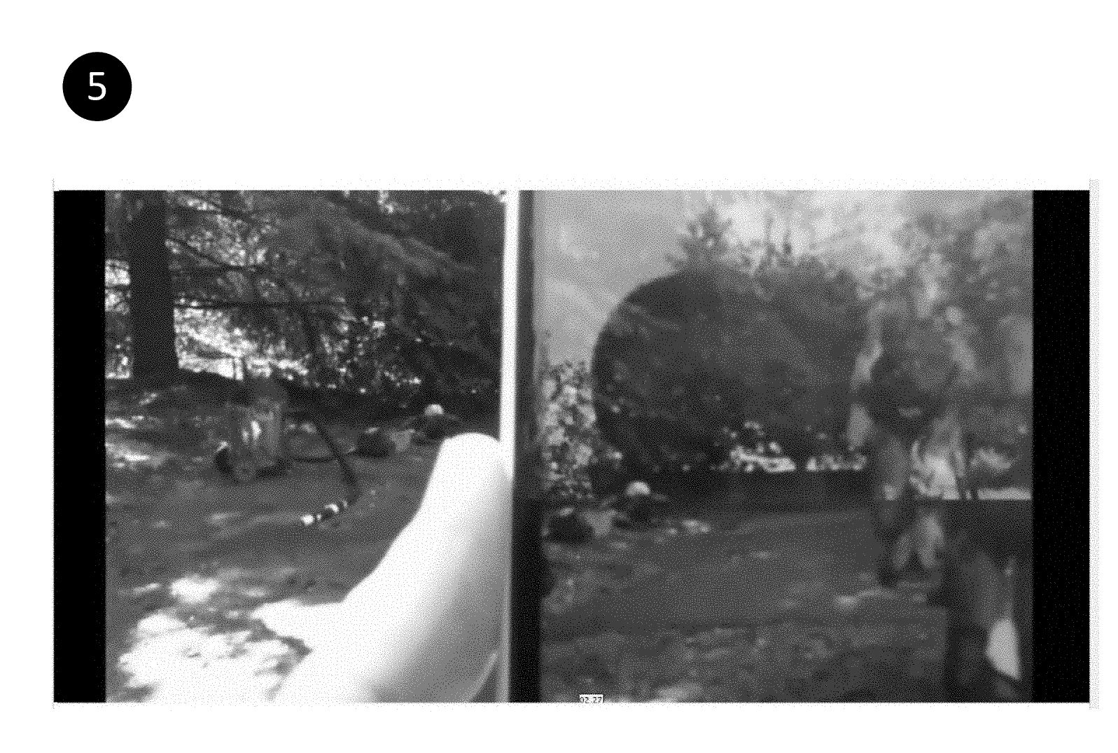

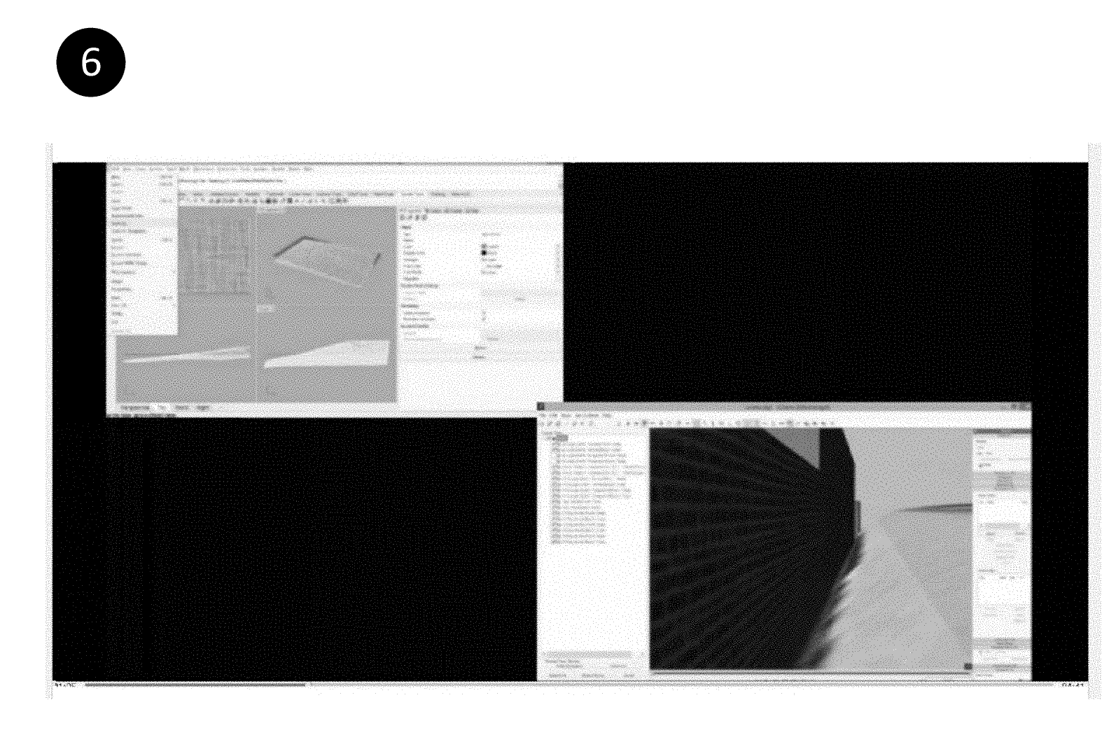

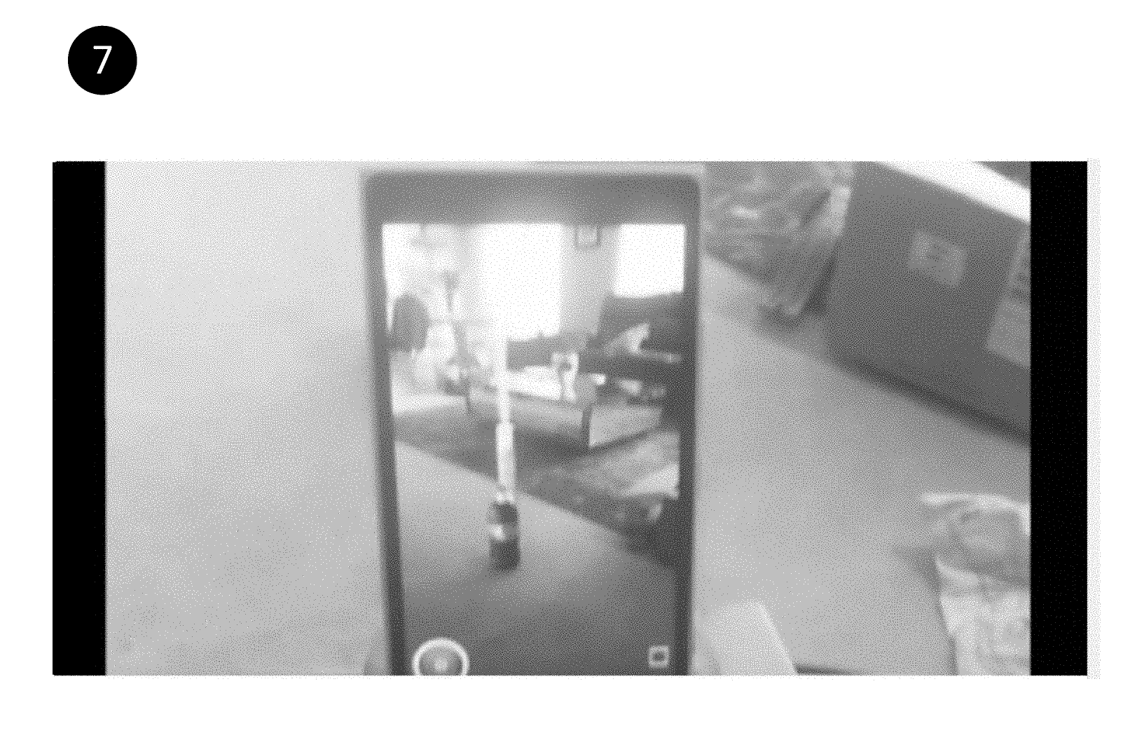

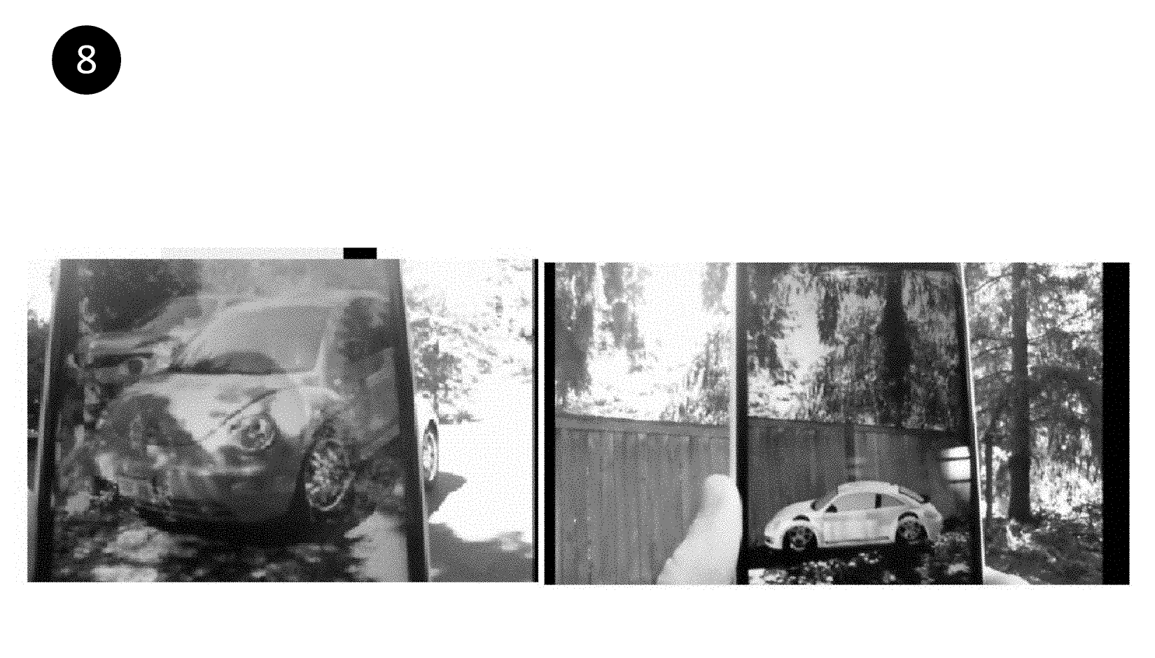

FIG. 3 depicts the flow surrounding the process by which in parallel each of the systems are calibrated and filtered.

FIG. 3—Blur/Fragmented Reality: Main Game Loop

FIG. 3 depicts the flow surrounding the. This process is done every 16 milliseconds, in parallel, with thread synchronization before rendering each frame. Some device readings are also run on event callbacks. Those event call backs are not a part of this threadpool, so they set the results of their calculations in static memory accessible by this threadpool. For fastest performance, if the memory is being written by the devices thread at the same time the game loop requests it, the error is caught and ignored and the previously fetched value is provided.

FIG. 4: Blur/Fragmented Reality: Metal Base Process

FIG. 4 depicts the flow surrounding the method by which objects are detected and the process by which they come back into the game as a compiled 3d model.

FIG. 5: Screenshot(s)

FIG. 5 depicts the Fragmented Reality component in action showing a game running elsewhere projected into the real world positionally.

FIG. 6: Screenshot(s)

FIG. 6 depicts the debug representation of the heightmap data used to set altitude and other physics properties.

FIG. 7: Screenshot

FIG. 7 depicts the Fragmented Reality component in action showing how the metelbase can serve up a particle effect because of its meta-relationships.

FIG. 8: Screenshot(s)

FIG. 8 depicts the Fragmented Reality component in action moving a car into the scene, which has all of the properties of a car (can drive, can steer, etc)

### CONCLUSION

The disclosed embodiments are illustrative, not restrictive. While specific configurations of the technology have been described, it is understood that the present invention can be applied to a wide variety of technology category. There are many alternative ways of implementing the invention.

Fragmented Reality has many applications beyond basic apps and games. A car salesman could use it to project the inside of an engine for a customer. An advertising agency (like for Coca-Cola) could position certain events, animations or object around the globe (for example, a large dancing coke bottle in the middle of a football field)

Fragmented Reality is a software component which is used to enhance existing applications.

Because Fragmented Reality is a component is can be used any piece of software including but not limited to games, maps, CAD, advertising, medical/surgery, presentation software.

Real time application of near field depth perception as well as far field surface, altitude and other geographic data. Object detection and transfer through specialized image detection, search, and 3d model association. Object to Object awareness with related actions (either physics or particle/visual effects)

The movement of the user and/or camera is grounded by NASA altitude measurements which are used at runtime to create a Heightmap and optional NASA imagery for top-down views

The grounding allows for realistic physics models to be applied and respected by the Fragmented Reality component. Fragmented Reality also leverages real-world, real-time data from publicly available feeds to augment a user's space with additional characteristics including but not limited to local architecture, traffic incidents, and current events.

What is claimed is:

1. A system for defining an augmented reality capability for a mobile phone or tablet device, said system comprising: a) a portable camera comprising a display and having the ability to show the current real world environment via the display; b) a mobile phone or tablet device comprising a computer processor and having the ability to show images, drawings, and models via the display; c) a software program executed by said computer processor for managing the display of said images, drawings, and models via the display; d) a set of controls whereby the user can interact with the software program; f) digital images acquired by the camera based upon user interaction specific view of a particular location; wherein the computer processor, via execution of the software program: i) receives from a user of the system a request for a particular image from the camera view ii) delivers the image to the cloud service component which; iii) receives the image, and uses image detection to determine what the image is then iv) delivers the image as digital 3d model v) or if not known by the cloud service, the software searches public domain models, finds one, compiles it and then delivers back the mobile phone or tablet device to be vi) rendered in the real world environment as displayed by the portable camera are aligned; vii) displays a digital 3d model, with a view of the current real-world environment; and viii) displays an adjusted digital artifact in response to an adjustment by the user of the view of the current real-world environment as displayed by the portable camera and ix) adjusts lighting projected onto the 3d object depending upon location and time of day, x) and applies physics to the object as it relates to the scene and xi) plays animations and particle effects when available

2. The system of claim 1, wherein said a digital image comprises an cropped image of a digital picture viewed through the camera b) cropped using object detection algorithms

3. The system of claim 1, wherein said digital 3d model: a) is related to the particular location; and b) allows some portion or portions of the view of the current real-world environment to remain visible.

4. The system of claim 1, wherein said digital 3d model comprises one or more of the following characteristics: a) it obscures or partly obscures portions of the view of the current real-world environment with content from the artifact; and b) it is rotatable, resizable or repositionable in response to changes in the view of the current real-world environment; and c) has the physical characteristics (hull and mass) that allow it to further interact with the real-world and other digital models and c) is lit by the environment based upon inputs from location, time of day and weather patterns, and d) plays animations if the model contains them and e) produces particle effects when available or when placed near-enough geographically to another digital 3d model

5. The system of claim 1, wherein said 3d digital model comprises an asset in a common industry format (FBX, OBJ) that is compiled to be drawn by 3D Software Engines.

6. The system of claim 1, wherein said digital artifact comprises a digitized 3 dimensional model associated with the particular location.

7. The system of claim 1, wherein the computer processor, via execution of the software program, displays the digital artifact superimposed on at least a portion of the view of a current real-world environment displayed by the portable phone or tablet device.

8. The system of claim 1, wherein the adjustment by the user of the view of the current real-world environment comprises moving closer to or further from a particular location.

9. The system of claim 1, wherein the adjustment by the user of the view of the current real-world environment comprises changing the altitude or azimuth of the view of the current real-world environment.
